(19) United States
(12) Patent Application Publication
(10) Pub. No.: US 2009/0013678 A1
(43) Pub. Date: Jan. 15, 2009

(54) HEAT EXCHANGER FOR THE EXHAUST GAS LINE OF A MOTOR VEHICLE, METHOD FOR PRODUCING A HEAT EXCHANGER AND ASSEMBLY TOOL HEREFOR

(76) Inventors: Andreas Capelle, Pulheim (DE); Andrej Repa, Trencin (SK); Zbynek Pomykal, Blatnice (CZ)

Correspondence Address: FRASER CLEMENS MARTIN & MILLER LLC, 28366 KENSINGTON LANE, PERRYSBURG, OH, 43551, US

(21) Appl. No.: 12/171,583

(22) Filed: Jul. 11, 2008

(30) Foreign Application Priority Data
Jul. 11, 2007 (DE) DE102007032331.1
Jun. 27, 2008 (DE) DE102008002746.4

(51) Int. Cl. F01N 3/02; F28D 15/00; B23P 15/26; B21D 41/02

(52) U.S. Cl. 60/320; 165/104.11; 29/890.045; 72/392

(57) ABSTRACT

A heat exchanger is disclosed for the exhaust gas line of a motor vehicle including at least one exchanger tube that is formed separately and disposed in a closed housing formed separately, a coolant flowing through the housing and around the outside of the exchanger tube. An inlet and/or an outlet of the exchanger tube are located outside the housing, wherein the exchanger tube is guided through a wall of the housing at a feed-through point in a coolant- and/or exhaust gas-tight manner. Additionally, a manufacturing method for the heat exchanger and an assembly tool which can be advantageously used in the method are disclosed.

### CROSS-REFERENCE TO RELATED APPLICATION

This application claims the benefit of German patent application Serial No. DE 102008002746.4 filed Jun. 27, 2008, which is hereby incorporated herein by reference in its entirety.

### FIELD OF THE INVENTION

The present invention relates to a heat exchanger for an exhaust gas train of a motor vehicle, and more specifically to an exhaust gas recirculation system for an internal combustion engine of a motor vehicle, a method for producing an exhaust gas heat exchanger for the recirculation system, and an assembly tool suitable for use within the scope of the manufacturing method.

### BACKGROUND OF THE INVENTION

As a result of the increasingly stringent legal regulations in relation to the exhaust gas emissions of motor vehicles, particularly in relation to the emission of nitrogen oxides, in the area of the internal combustion engine the return of combustion exhaust gases to the inlet side of the internal combustion engine is prior art. The combustion gases themselves do not participate again in the combustion process in the combustion chamber of the internal combustion engine but thus constitute an inert gas which dilutes the mixture of combustion air and fuel in the combustion chamber and provides inner mixing. In this way, it is possible to minimize the occurrence of so-called hot spots during the combustion process which are characterized by locally extremely high combustion temperatures. Such very high combustion temperatures promote the formation of nitrogen oxides and must therefore be avoided at all costs.

Since the efficiency of an internal combustion engine typically depends on the temperature of the combustion air fed to the combustion chamber of the internal combustion engine, the combustion gases from the combustion chamber of the engine cannot be fed back immediately to the intake side. Rather, a significant reduction in the combustion temperature is required. Typical outlet temperatures of the combustion gases from the combustion chamber of the internal combustion engine are in the range of 900° C. or higher whereas the temperature of the combustion air fed to the inlet side of the combustion chamber of the internal combustion engine should not be above 150° C., preferably significantly less than this. For cooling the returned combustion gases, it is known from the prior art to use so-called exhaust return coolers. Various designs are known from the prior art in which the combustion gases to be cooled are passed through exchange tubes with a coolant flowing around the outside, the coolant generally being the cooling water of the motor vehicle. In order to enhance the efficiency it is proposed in the prior art to pass the combustion gases to be cooled through a bundle of exchanger tubes connected in parallel in terms of fluid flow, the coolant generally flowing around the tubes.

Known from DE 10 2005 055 482 A1 is an exhaust gas heat exchanger for an internal combustion engine in which those surfaces coming in contact with the hot combustion gases are executed as corrosion-resistant steel surfaces. The heat exchanger tubes and the housing in which the heat exchanger tubes are located are configured as separate parts which need to be joined together during the production process.

General information of the exhaust gas return technology in internal combustion engines in motor vehicles can be deduced, for example, from DE 1000 119 54 A1.

It would be desirable to produce a heat exchanger for an exhaust train of a motor vehicle that offers advantages in manufacturing costs over the prior art constructions; provide a method for assembling the heat exchanger; and provide an assembly tool suitable for facilitating the assembly of the heat exchanger according to the method.

### SUMMARY OF THE INVENTION

Compatible and attuned with the present invention, a heat exchanger for an exhaust train of a motor vehicle that offers advantages in manufacturing costs over the prior art constructions; a method for assembling the heat exchanger; and an assembly tool suitable for facilitating the assembly of the heat exchanger according to the method, have surprisingly been discovered.

A heat exchanger according to the invention is provided for the exhaust gas line of a motor vehicle. It comprises at least one separately configured, exhaust-gas-carrying exchanger tube which is located in a separately configured closed housing. This housing for its part has cooling flowing therethrough, which coolant therefore also flows around the outside of the exchanger tube. The coolant can, for example, be the coolant of the internal combustion engine itself, i.e. the exhaust gas heat exchanger can be located in the coolant circuit of the motor vehicle. The inlet and/or the outlet of the at least one exchanger tube are located outside the housing of the heat exchanger, the exchanger tube being guided through a wall of the housing at least one feed-through point in a coolant- and/or exhaust gas-tight manner. The media coolant and exhaust gas can optionally also be exchanged.

According to the invention, a mechanical support structure lying in the interior of the housing is now formed on the outer surface of the exchanger tube and a mechanical retaining structure lying outside the housing is formed at the exterior end of the exchanger tube.

The two support or retaining structures substantially simplify the assembly process required to produce the heat exchanger according to the invention and therefore allow a significant cost saving. They also ensure increased reliability of the coolant- or gas-tight passage of the at least one exchanger tube through the wall of the heat exchanger.

In an embodiment, the mechanical support structure lying in the interior of the housing is configured in the form of one or a plurality of expanded tube sections. Alternatively, it is also possible to attach a separately configured support structure to the outside of the exchanger tube and fix it there by means of suitable mechanical means. As an example, mention is made here of an annular collar which is pushed onto the outside of the exchanger tube and clamped firmly there, fixed or soldered by means of spot welds.

The mechanical retaining structure lying outside the housing at the outer end of the exchanger tube can again advantageously be formed by one or a plurality of expanded tube sections. In particular, the outer end of the exchanger tube can be completely or partially beaded for this purpose to form a collar-like retaining structure. Naturally, it is also possible here to provide a separately configured mechanical retaining structure, for example, in the form of a ring which is pushed onto the outer end of the exchanger tube during assembly of the heat exchanger according to the invention and is mechanically fixed there in a suitable manner.

The separate configuration of housing and exchanger tube in the heat exchanger according to the invention allows the same to be manufactured particularly simply and also makes it possible to use materials for the heat exchanger according to the invention which are in each case adapted to the locally prevailing requirements with regard to corrosion resistance and heat resistance of the materials.

It has proved to be advantageous, for example, if the exchanger tube or tubes are made of a corrosion-resistant and heatproof material such as, for example, stainless steel. Stainless steel also has the advantage of being flexible so that the curvature according to the invention of the flow path in the exchanger tube/in the exchanger tubes can easily be achieved. If less stringent requirements are imposed on the corrosion resistance or on the heat resistance, it can be sufficient to make the exchanger tube/exchanger tubes from aluminum or aluminum alloy. Seamlessly drawn tubes are preferably used.

The housing of the exhaust gas heat exchanger according to the invention can naturally also consist of stainless steel, for example, a seamlessly drawn stainless steel tube with an inserted bottom piece. Particular advantages are achieved if the housing is configured as a cast part, i.e. in particular consists of a castable material such as, for example, aluminum, magnesium, gray cast iron or a plastic having a sufficient temperature resistance. However, since the housing of the exhaust gas heat exchanger according to the invention does not come in contact with the corrosive combustion exhaust gases and is exposed to temperatures lying at typical coolant temperatures such as in the range below 150°, the aforesaid significantly more favorable materials can be avoided. In particular, the housing can be produced in a casting process, for example, by means of plastic or metal, injection molding. In addition to the cost advantages already mentioned and the fact that a cast housing is easier to manufacture, substantial savings in weight can also be reduced with cast housings compared with stainless steel housings, which is another advantage of the exhaust gas heat exchanger according to the invention since an undesirable side effect of the increasing complexity of motor vehicles is their continuous increase in weight which goes against the efforts of motor vehicle manufacturers to reduce the consumption and emissions of motor vehicles.

In a particularly preferred embodiment, the heat exchanger comprises a housing configured as at least two-part. In particular, the housing can form a housing cover and a jacket portion, wherein the jacket portion can be configured as pot-shaped and can be tightly closed by the housing cover.

In this preferred embodiment, the exchanger tube is then guided in a gas- and fluid-tight manner through at least one of the two housing parts, for example, through the housing cover. In this way, the inlet and the outlet of the exchanger tube are therefore located outside the housing. In particular, the exchanger tube can be mechanically firmly connected to this housing part at the points at which it is guided through the housing part so that the exchanger tube is completely mechanically supported on this housing part.

The two housing sections, in particular therefore the housing cover and the jacket portion are preferably configured as separate parts which are connected to one another by means of mechanical retaining means such as, for example, screws or rivets.

Since the housing cover or that housing section through which the at least one exchanger tube is guided is in thermal contact with the exchanger tube, further advantages are achieved if this housing section, i.e. for example, the housing cover, is made of a corrosion-resistant and heat-proof material such as stainless steel. With certain restrictions, the use of aluminum or aluminum alloy or other metallic materials having suitable heat resistance is also suitable here provided that this can be connected in a suitable gas- and liquid-tight manner to the exchanger tube guided therethrough, for example, by means of soldering, welding or possibly also adhesive bonding.

Particular advantages are obtained in this connection if the housing section in question, i.e. in particular the housing cover and the at least one exchanger tube are made of the same material, i.e. for example stainless steel.

Further advantages are obtained if the feed-through points, i.e. those points at which the at least one exchanger tube is guided through the wall of the housing on the inlet side and on the outlet side, are substantially arranged in a common plane E. The inlet and the outlet of the exchanger tube can be substantially arranged in a common plane E′ which in particular can coincide with the aforesaid common plane of the feed-through points. One of the planes E or E′ can form an interface for a connection of a heat exchanger to the exhaust gas system of the motor vehicle whereby the heat exchanger according to the invention can be assembled particularly easily.

This advantages can be increased still further by arranging the coolant inlet and the coolant outlet for the coolant flowing through the housing of the heat exchanger according to the invention likewise in the plane E of the feed-through points of the exchanger tube or in the plane E′ of the inlet and the outlet of the exchanger tube. In a particularly preferred embodiment, the planes E and E′ coincide so that both the feed-through points and also the inlet and outlet of the exchanger tube and also the coolant inlet and coolant outlet are arranged substantially in one plane. This common plane can then advantageously form an interface for a connection of the heat exchanger both to the exhaust gas system of the motor vehicle and also to the coolant system of the motor vehicle.

Further advantages are obtained if the exchanger tubes of the heat exchanger according to the invention are substantially one-piece between their inlet and their outlet, but are at least one-piece between the aforesaid feed-through points. In particular, the at least one exchanger tube can be substantially semicircular or bent in a U shape between its inlet and its outlet or its feed-through points.

In a preferred exemplary embodiment, instead of a single exchanger tube in the heat exchanger according to the invention, there is provided a bundle of exchanger tubes which are connected fluid-dynamically in parallel. In particular, this bundle of exchanger tubes should be configured such that the flow paths formed in the individual exchanger tubes between their respective inlets and outlets have no contact with the flow paths in the adjoining exchanger tubes. This avoids the exhaust gas stream to be cooled having to pass many times through cross-sectional constrictions on its passage through the exhaust gas heat exchanger according to the invention. On the one hand, this results in a significantly reduced flow resistance of the heat exchanger according to the invention and on the other hand, it has been found in practical operation that any constriction in the flow path inside an exhaust gas heat exchanger forms a location at which condensate contained in the returned combustion exhaust gas deposits, which in the long term can result in partial or complete blockage of the heat exchanger and therefore failure of the entire exhaust gas return system of the motor vehicle.

If a bundle of exchanger tubes is used, it has proved to be particularly optimal when using water as coolant if the minimum distance d between the outer surfaces of the adjacently arranged exchanger tubes is in the range between 0.5 mm and 5 mm. Particularly preferred here is a gap width between 1 and 2 mm which again in particular with reference to water as coolant, constitutes an optimum in relation for flow resistance for the coolant on the one hand and an optimization of the surface of the exchanger tubes around which flow takes place in relation to the volume through which coolant flows on the other hand.

With regard to the dimensions of the exchanger tubes in a the heat exchanger according to the invention, it has proved to be favorable if the at least one exchanger tube has an outside diameter D between 1 and 15 mm. Particularly preferred in this case is the range between 6 and 12 mm for which the ratio between the established pressure loss or flow resistance for the return combustion exhaust gas on the one hand and the thermal resistance of the exhaust gas heat exchanger according to the invention on the basis of the tube cross-section to the inner surface of the heat exchanger tubes on the other hand has proved to be optimal.

If a bundle of exchanger tubes is used, both the mid points of the inlets and of the outlets of the exchanger tubes lie on the mid points of an orthogonal or hexagonal grid. Both the inlets and the outlets are preferably arranged on grid points of equivalent grids. Alternatively or additionally, the feed-through points at which the individual exchanger tubes are guided through the wall of the housing of the heat exchanger on the inlet side and on the outlet side could be arranged on grid points of comparable grids. Such an arrangement of the inlets or outlets of the exchanger tubes or of their feed-through points through the wall of the exchanger housing again allows particularly efficient usage of the space available inside the exchange housing.

In a particularly preferred further development of the heat exchanger according to the invention comprising a bundle of exchanger tubes, the exchanger tubes are arranged so that they cross at least in pairs. In this way, particularly efficient use of space inside the housing of the heat exchanger can be ensured.

In a simple first embodiment, the at least one exchanger tube can be configured as a smooth-walled tube where smooth-walled relates both to its inner and to its outer surface. In an improved embodiment, the at least one exchanger tube is configured as a twisted tube i.e. a spiral structure is formed on the inner surface of the exchanger tube, which sets the through-flowing gas stream into vortex motion as it flows through the (bent) exchanger tube.

In particular, such a spiral structure can be brought about by incorporating a spiral indentation structure in the wall of an otherwise smooth-walled tube e.g. made of stainless steel.

A method according to the invention is provided for mounting a separately configured e.g. exhaust-gas-carrying exchanger tube of a heat exchanger for the exhaust gas line of a motor vehicle. In the heat exchanger, the exchanger tube is located in a separately configured closed housing which has a coolant (or alternatively also exhaust gas) flowing therethrough. In this case, the medium flowing through the housing flows around the outside of the exchanger tube. The inlet and/or the outlet of the exchanger tube are located outside the housing, and the exchanger tube is guided through a wall of the housing at a feed-through point in a coolant- and/or exhaust gas-tight manner. The exchanger tube itself can either have exhaust gas or coolant flowing therethrough. The method according to the invention is characterized by the following process steps:
a) guiding the exchanger tube through the wall of the housing,
b) forming a mechanical support structure lying in the interior of the housing on the outer surface of the exchanger tube,
c) forming a mechanical retaining structure lying outside the housing at the exterior end of the exchanger tube,
d) making the coolant- and/or gas-tight mechanical connection between the housing and the exchanger tube.

In a particularly preferred embodiment of the method according to the invention, steps b) and c) are carried out substantially at the same time, for example, using a suitable assembly tool.

In an alternative but likewise advantageous embodiment of the method according to the invention, step a) is carried out after step b) and before step c).

In another advantageous embodiment of the method according to the invention, in order to form a mechanical support structure lying in the interior of the housing on the outer surface of the exchanger tube, this exchanger tube itself is expanded at least in sections, for example, using a suitable assembly tool designed as a pipe-expanding tool. Furthermore, the mechanical retaining structure (28) lying outside the housing at the outer end of the exchanger tube can likewise advantageously be produced by means of expansion of the exchanger tube, at least in sections. In particular, the outer (short) end of the exchanger tube can be beaded for this purpose.

A pipe expanding tool can advantageously be inserted into the inside of the exchanger tube to carry out steps b) and/or c).

The coolant- and/or gas-tight mechanical connection between the housing and the exchanger tube can advantageously be made in a further process step by means of one of the following methods:
a) soldering,
b) welding,
c) crimping and/or
d) adhesive bonding.

Naturally, all other joining methods known from the prior art as suitable for the task, in particular the materials used and the temperature range in question can be used in principle.

With regard to the production of the coolant- and/or gas-tight mechanical connection between the housing and the exchanger tube by means of crimping, it should be noted at this point that when forming the mechanical support structure and the mechanical retaining structure by at least partial expansion of the exchanger tube, this can be executed so that a coolant- and/or gas-tight connection between the housing and the exchanger tube is obtained immediately without executing further processes. This should be regarded as a special case of crimping.

With regard to the soldering of exchanger tube and housing, it has proved to be advantageous if the outer surface of the exchanger tube is coated with a suitable solder, at least in sections, before carrying out the soldering. Likewise it has provided advantageous if the inner and/or outer surface of the housing is additionally or alternatively coated with solder, at least in sections, before carrying out the soldering. In the procedure described hereinbefore, for example, automated fitting of the housing/housing cover with the exchanger tubes can be effected and these fixed mechanically on the housing forming the support or retaining structures. The exchanger tubes and the housing/housing cover thus combined to form a mechanical unit can then be passed through a soldering furnace, wherein no additional measures are required to fix the exchanger tube or tubes mechanically on the housing/housing cover during the soldering process.

An assembly tool to be used advantageously in the method according to the invention has the following features:
a) the tool forms a mandrel which can be inserted into the end of an exchanger tube,
b) on actuating the tool, at least two different tube sections are expanded to form
c) the mechanical support structure on the outer surface of the exchanger tube and
d) the mechanical retaining structure at the outer end of the exchanger tube.

In this case, for example, the cross-section of the mandrel to be inserted into the exchanger tube can be enlarged in sections. In particular, this cross-sectional enlargement can be based on the expansion of a flexible body, for example, consisting of a synthetic rubber.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawing which:

FIG. 1 is an exploded view of a first exemplary embodiment of an exhaust gas heat exchanger according to the invention;

FIG. 2 is a perspective view of the assembly interface S of the exhaust gas heat exchanger according to a first exemplary embodiment;

FIG. 3 is a perspective view of a bundle of exchanger tubes of an exhaust gas heat exchanger according to a second exemplary embodiment;

FIG. 4 is a schematic illustration of an exchanger tube of the heat exchanger according to FIG. 1;

FIG. 5 is a sectional view through the inlet/outlet openings of the exchanger tubes in the area of a housing cover;

FIG. 6 is a partial sectional view of the inlet/outlet opening of the exchanger tubes;

FIG. 7 is a perspective view of a tube expanding tool in the actuated state;

FIG. 8 is a partial section view according to FIG. 6 with the tube expanding tool inserted in the inlet/outlet opening of the exchanger tube and actuated;

FIG. 9 is an elevational view of the interface S formed by a housing cover in which the inlet and outlet openings are arranged on grid locations of an orthogonal grid;

FIG. 10 is an elevational view of the interface S formed by a housing cover in which the inlet and outlet openings are arranged on grid locations of a hexagonal grid, and

FIG. 11 is an exploded view of a third exemplary embodiment of an exhaust gas heat exchanger according to the invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

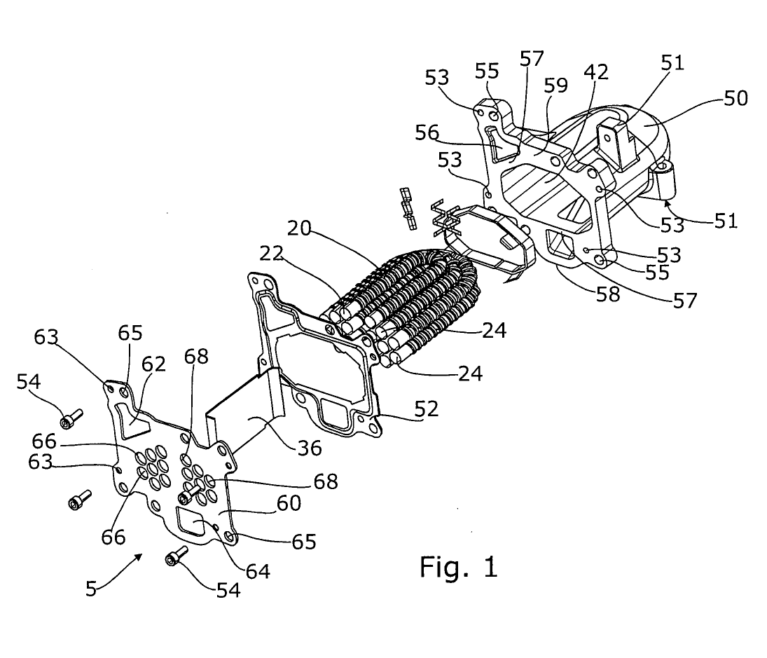

FIG. 1 shows an exploded diagram of an exhaust gas heat exchanger 1 according to the invention in a first exemplary embodiment. The heat exchanger 1 comprises a housing 40 consisting of a jacket portion 50 which is closed by means of a housing cover 60. The jacket portion 50 is configured as a cast part and in particular consists of aluminum compression casting. Alternatively, in the exemplary embodiment shown, it is possible to manufacture the jacket portion 50 of any material which, on the one hand, can be processed in a casting process and on the other hand, has sufficient thermal stability. However, since the jacket portion 50 of the heat exchanger 1 according to the invention only comes in contact with the coolant which generally comes from the coolant circuit of the motor vehicle, in most applications a temperature resistance to temperatures of up to 150° C. is sufficient. Magnesium or magnesium alloys, gray cast iron or heat-resistant and injection-moldable plastics have proved to be further materials for the jacket portion.

At the front, the jacket portion 59 forms a flange 59 for connection to a housing cover 60. In the exemplary embodiment shown, the housing cover 60 consists of a stamped stainless steel plate having a thickness of a few millimeters, preferably about 2 mm. The jacket portion 50 is connected in a liquid- and gas-tight manner to the housing portion 60 with an interposed seal 52 which is configured as a metal thickness seal in the exemplary embodiment shown. In this case, the housing cover 60 is screwed to the flange 59 of the jacket portion 50 by means of screws 54, for which the jacket portion 50 has a plurality of large threaded holes 55. At corresponding positions, the housing cover 60 has large-diameter through-holes 65 through which suitably-sized screws 54 can be guided and inserted into the threaded holes 55 so that the housing cover 60 can be screwed to the jacket portion 50.

The jacket portion 50 forms an inner space 42 which is provided to receive a bundle of U-shaped bent exchanger tubes 20. In this case, the exchanger tubes 20 have identical tube dimensions such as inside and outside diameter, but the opening width W of the U-shaped profile varies. However, the shaping of the inner space 42 and therefore also of the jacket portion 50 as a whole is adapted to the shaping of the bundle of exchanger tubes 20 so that the usage of the inner space 42 by the bundle of exchanger tubes 20 is as efficient as possible.

At their respective ends the exchanger tubes 20 each form an inlet 22 and an outlet 24. The ends of the exchanger tubes 20 are guided into corresponding holes in the housing cover 60 which form feed-through points 66, 68 for the inlets or outlets of the exchanger tubes 20. At the same time, the inlets and outlets 22, 24 of the exchanger tubes 20 are guided through the feed-through points 66, 68 formed in the housing cover 60, and the exchanger tubes 20 are connected in a gas- and liquid-tight manner to the housing cover 60 at the feed-through points 66, 68, for example, by means of soldering or welding. This provides mechanical support of the exchanger tubes 20 on the housing cover 60.

In an embodiment, the exchanger tubes 20 consist of thin-walled stainless steel tubes, the exchanger tubes 20 being provided with an embossed structure, so that a spiral structure 26 rises from the inner surface of the exchanger tubes 20. The bundle of exchanger tubes 20 is arranged so that all the inlets 22 and all the outlets 24 are each arranged in a cohesive group so that the heat exchanger 1 according to the invention can easily be connected to the exhaust gas system of the motor vehicle. For this purpose the front side of the housing cover 60 forms an assembly interface S which, as a result of the planar design of the housing cover 60, is configured as substantially flange-like. For mounting the heat exchanger 1 on the motor vehicle, further threaded holes 53 are formed in the jacket portion 50 which have a reduced inside diameter compared with the threaded holes 55. Corresponding through holes 63 are formed in the metal bead seal 52 and in the housing cover 60. By this means, the heat exchanger 1 can be connected to the exhaust gas and coolant system of the motor vehicle by means of a plurality of screws not shown in FIG. 1.

In addition to the inner space 42 not occupied by the bundle of exchanger tubes 20, the jacket portion 50 forms an inlet channel 56 and an outlet channel 58 for a coolant which, for example, can comprise cooling fluid of the motor vehicle. The inlet channel 56 and outlet channel 58 are arranged in this case so that when the heat exchanger 1 is operated as prescribed, a flow path extending from top to bottom (in FIG. 1) is obtained through the inner space 42 of the jacket portion 50 so that the bundle of exchanger tubes is more intensively washed with coolant. In order to achieve interaction of the coolant with the surfaces of the exhaust-gas-carrying exchanger tubes 20 which is as intensive as possible, a baffle plate 36 is further disposed inside the sides of the U-shaped exchanger tubes 20, which, in the exemplary embodiment shown, again preferably consists of stainless steel and is butt-welded or soldered to the housing cover 60 likewise consisting of stainless steel. The baffle plate 30 extends the flow path of the coolant in the inner space 42 of the housing and thus ensures more intensive thermal exchange between the exhaust gas flowing in the exchanger tubes 20 and the exhaust gas flowing in the inner space 42.

The inlet channel 56 formed in the jacket portion 50 and the outlet channel 58 likewise end in the flange 59 formed by the jacket portion 50, wherein webs 57 are formed at the ends of the channels 56 and 58, which form a mechanical support for the metal bead seal 52 resting on the flange 59. This likewise forms openings for the coolant flowing through the heat exchanger 1 which correspond to the coolant inlet 62 and coolant outlet 64 formed in the housing cover 60. In the assembled heat exchanger 1, coolant can thus be thus be supplied via the front side of the housing cover 60 via the coolant inlet 62 and removed via the coolant outlet 64 and the combustion exhaust gas to be cooled can be supplied via the inlets 22 of the exchanger tubes 20 and removed via the outlets 24. In the design shown, this is possible via a single common assembly interface S.

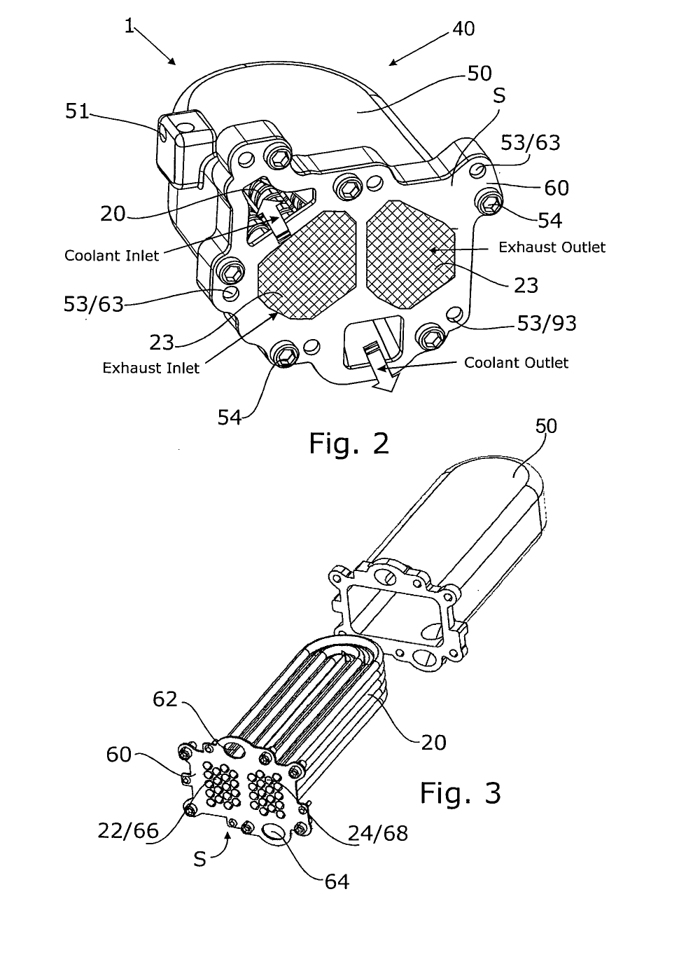

This is particularly clear from the diagram according to FIG. 2 which shows a plan view of an assembly interface of the heat exchanger 1 in a slightly modified embodiment. The coolant inlet 62 formed in the housing cover 60 and the coolant outlet 64 can be clearly identified. However, the plurality of inlets 22 and outlets 24 of the exchanger tubes 20 is covered by grid structures 23 in the diagram according to FIG. 2 but the arrangement of the inlets 22 and outlets 24 in the housing cover 64 substantially corresponds to the configuration shown in FIG. 1. Otherwise, the heat exchanger according to the diagram in FIG. 2 differs substantially in respect of the changed arrangement of fastening points 51 on the jacket portion 50, wherein these fastening points 51 are used for fastening the heat exchanger 1 to assembly structures of the motor vehicle.

FIG. 3 shows a perspective view of a bundle of exchanger tubes 20 of a heat exchanger 1 in a third embodiment. Compared with the heat exchanger 1 according to FIG. 1, the bundle of exchanger tubes 20 shown here differs substantially in that the exchanger tubes 20 comprise smooth, seamlessly drawn thin-walled stainless steel tubes having no spiral structure 26 such as is shown in FIG. 1. In addition, the exchanger tubes 20 are arranged so that they each cross in pairs which can be seen at the inversion points of the U-shaped exchanger tubes 20 in FIG. 3.

FIG. 4 now shows a plan view of a single exchanger tube 20 of the heat exchanger 1 according to the first exemplary embodiment. The exchanger tube 20 has a free length designated by L which, depending on the dimensioning of the heat exchanger 1 can lie in the range between two and 30 cm, wherein typical dimensions of L in the range of 5 cm are suitable for use in motor vehicles having lower-power internal combustion engines. For passenger cars having higher powers of 100 kW and above, dimensions in the range of L between 10 and 15 cm can be appropriate. Dimensions of L=20 cm and above can be suitable for use in heavy goods vehicles.

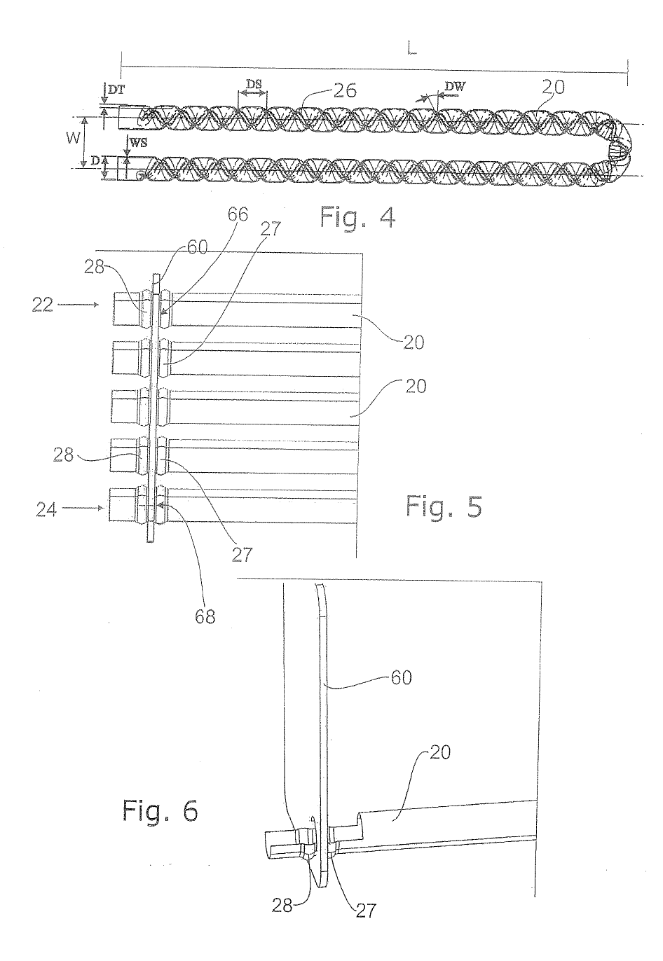

The exchanger tube 20 has an outside diameter D which is typically in the range between 1 and 15 cm, preferably in a range between 6 and 12 mm, since this has proved to be particularly suitable for use of the heat exchanger as prescribed as an exhaust gas heat exchanger for a motor vehicle. It can be seen from FIG. 4 and FIG. 5, which shows a section through the exchanger tube 20 from FIG. 4 in perspective view, that values in the range of 0.1 to 1 mm are suitable for a stainless steel connection, depending in particular on the length L of the exchanger tube in the specific heat exchanger 1. The wall thickness WS of the exchanger tube 20 is preferably in the range of 0.3 to 0.6 mm. For the spacing W of the sides of the U-shaped exchanger tube 20 it has been found that this is preferably greater than or equal to twice the outside diameter D of the exchanger tube 20. In particular, it holds that: W≧2.2×D, where it is found that the side width W which correlates directly with the bending radius of the U-shaped bent exchanger tube 20 is W=2R, when a thin-walled tube provided with a continuous spiral structure 26, made of stainless steel or aluminum, for example, is used as exchanger tube 20. A particularly small side width W is favorable for using the inner spatial volume of the housing 40 as efficiently as possible and is to be preferred because of the very limited available space in a motor vehicle.

FIG. 5 shows a section through a housing cover 60 in the area of the holes 66, 68 through which the inlet- or outlet-side ends 22, 24 of the various exchanger tubes 20 are guided. The exchanger tubes 20 each have a support structure 27 at their inlet- or outlet-side ends which is arranged inside the housing interior space and forms a mechanical support for the tube ends towards the housing cover 60. This support structure can be formed, for example from one or more punctiform projections, but in the exemplary embodiment according to FIG. 4, is defined as a peripheral protuberance.

The outside end of the exchanger tube 20 is completely peripherally beaded to form the retaining structure 28 so that a mechanical support of the exchanger tube 20 on the housing cover 60 is obtained overall from the combination of the support structure 27 and the beaded end 28. This results in a substantial simplification in the manufacture of the heat exchanger 1 according to the invention since the exchanger tubes 20 are already mechanically pre-fixed in the housing cover 60. In this way, an additional fixing of the exchanger tubes 20 on the housing cover 60, for example, by means of (laser) spot welds during a subsequent soldering or welding of the exchanger tube ends to the housing cover 60 can be dispensed with. FIG. 6 shows the support structure 27 and the retaining structure from FIG. 5 for illustration again in a partial sectional view of an exchanger tube 20.

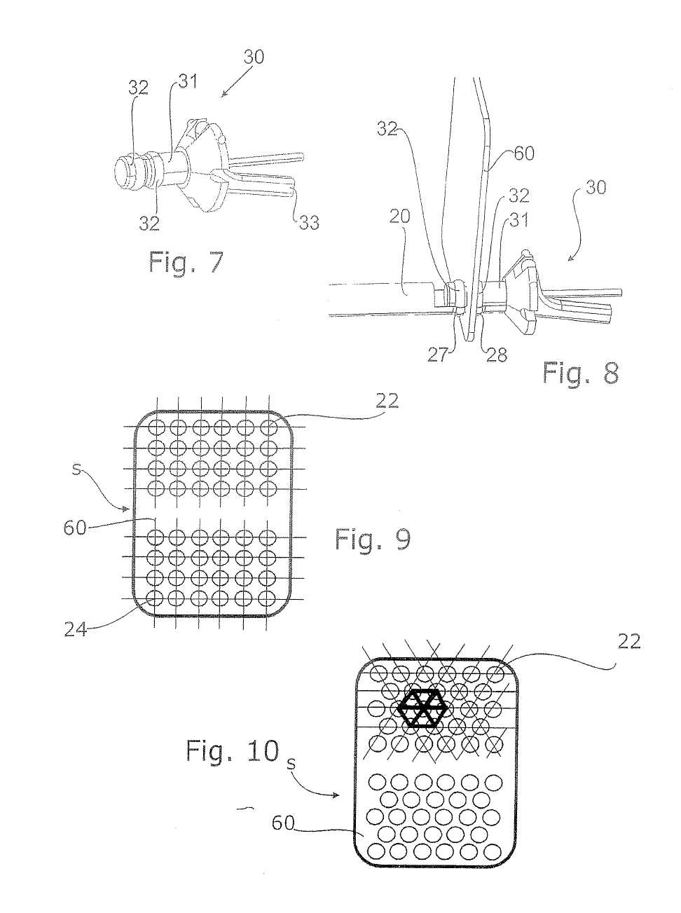

The support and retaining structures 27, 28 shown in FIGS. 6 and 7 can be inserted very simply into the end of the exchanger tube, e.g. by passing an exchanger tube 20 having the same-shaped inside and outside diameter through a corresponding hole in the housing cover 60. Then, the peripheral protuberance 27 and at the same time, the beaded edge 28 are produced e.g. using a suitable pipe expanding tool 30. A suitable tool is shown as an example in FIG. 7.

The pipe expanding tool 30 comprises a mandrel 31 whose outside diameter is adapted to the inside diameter of the exchanger tube 20, so that the mandrel 31 can be inserted into the end of the exchanger tube 20. The mandrel 31 is formed, in sections, of a flexible incompressible material such as synthetic rubber. These flexible elements are designated by the reference numeral 32 in FIG. 7. The pipe expanding tool 30 also has a handle 33, upon actuation whereof the length of the mandrel 31 is shortened, thereby compressing the flexible element 32. Since synthetic rubber is a substantially incompressible material, it yields outwards and thereby expands the outside diameter of the mandrel 31 in sections. This state is shown in FIG. 7.

FIG. 8 shows the pipe expanding tool 30 according to FIG. 7 inserted into the tube end of the exchanger tube 20 according to FIG. 6. At the same time, the pipe expanding tool 30 is in its actuated state. It can be seen from FIG. 8 how, upon actuation of the pipe expanding tool 30, the compressed flexible elements 32 completely peripherally expand the exchanger tube 20 inside and outside the housing 40 directly adjacent to the housing cover 60 and thereby form the support structure 27 and the retaining structure 28. In the exemplary embodiment shown according to FIGS. 5 and 6, the retaining structure 28 does not comprise a beaded end of the exchanger tube 20 but rather, in this exemplary embodiment, the retaining structure 28 is formed similarly to the support structure 27 in the form a pipe cross-section expanded in sections. However, it is also possible to bead the outer end of the exchanger tube 20 using the pipe expanding tool 30 according to FIG. 7, assuming that the exchanger tube 20 has been cut suitably short.

FIG. 9 again shows a schematic plan view of the inlets 22 and the outlets 24 of a plurality of exchanger tubes 20 which are arranged as an exchanger tube bundle in the inner space 42 of a heat exchanger housing 40. It can be seen that both the inlets 22 and the outlets 24 are arranged on the grid points of an orthogonal grid.

A more efficient utilization of space is obtained in the arrangement of the inlets 22 or outlets 24 according to FIG. 10. Here the inlets 22 or outlets 24 are arranged on grid points of a hexagonal grid which means that each inlet 22 or each outlet 24 is surrounded by six neighboring inlets 22 or outlets 24. The highest possible filling of space in the interior 42 of the housing 40 by the exchanger tubes 20 can be achieved in this configuration.

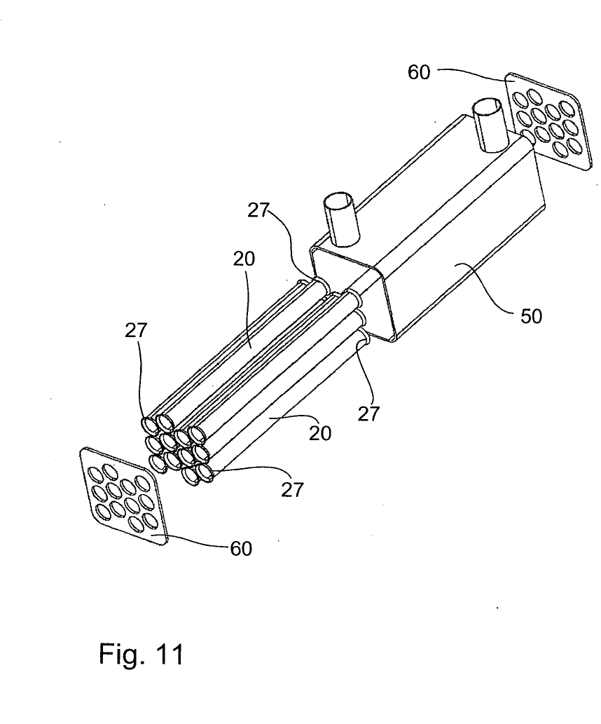

Finally, FIG. 11 shows a third exemplary embodiment of a heat exchanger 1 according to the invention in which the exchanger tubes 20 are not configured as bent in a U-shape but rather run rectilinearly through the interior of the housing 40. Accordingly, the heat exchanger 1 from FIG. 11 has two housing covers 60 with which the jacket portion 50, configured as a cast part for example, is closed in a gas- and liquid-tight manner. The ends of the exchanger tubes 20 are guided through the cover portions 60 formed of a stainless steel, a bundle of exchanger tubes 20 again being provided here. The support structures 27 brought onto the outer surfaces of the exchanger tubes 20 in the area of their ends before joining the components shown together to form the operational heat exchanger are indicated schematically in the exploded diagram in FIG. 11 but these are located horizontally inside the housing 40 in the assembled heat exchanger 1. In the exemplary embodiment shown, these structures consist of annular elements which are pushed onto the ends of the exchanger tubes 20 before the final assembly of the heat exchanger 1 and are mechanically fixed there by means of a spot weld before the final assembly of the heat exchanger 1.

In order to form the gas- and liquid-tight passage of the exchanger tubes 20 through the housing cover 60, the exchanger tubes 20 are then soldered to the housing cover 60 in a gas- and liquid-tight manner by means of the soldering process which has already been described previously. At least in the area of a housing cover 60 the exchanger tubes 20 are fixed for the soldering process on the housing cover by formation of the additional retaining structure 28 at the outer end of the exchanger tubes 20. This can again also be achieved by beading the outer end of the exchanger tube.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A heat exchanger for an exhaust gas system of a motor vehicle comprising:
a closed housing; and
an exhaust gas carrying exchanger tube disposed in the housing, a first end and a second end of the exchanger tube extending outside the housing and an outer surface of the exchanger tube adjacent the first end and the second end thereof forming a substantially fluid tight seal with the housing, the exchanger tube including a mechanical support structure on the outer surface thereof located inside the housing and a mechanical retaining structure on the outer surface thereof located outside the housing.

2. The heat exchanger according to claim 1, wherein at least one of the mechanical support structure and the mechanical retaining structure are formed by at least one expanded section of the exchanger tube.

3. The heat exchanger according to claim 2, wherein the expanded section of the exchanger tube is a bead.

4. The heat exchanger according to claim 1, wherein the substantially fluid tight seals between the housing and the exchanger tube are substantially arranged in a common plane.

5. The heat exchanger as set forth in claim 1, wherein the exchanger tube is substantially made from one piece between points at which the exchanger tube forms a seal with the housing.

6. The heat exchanger as set forth in claim 1, wherein the exchanger tube is curved in a substantially U-shape between points at which the exchanger tube forms a seal with the housing.

7. The heat exchanger as set forth in claim 1, further comprising a plurality of exchanger tubes disposed in the housing, the tubes forming a bundle connected in parallel in terms of fluid flow.

8. The heat exchanger according to claim 1, wherein the exchanger tube is one of a smooth-walled tube and a twisted tube forming a spiral structure.

9. The heat exchanger according to claim 1, wherein the housing includes at least one housing cover and at least one jacket portion, the housing cover substantially closing the jacket portion, and the first end and the second end of the exchanger tube extending through the housing cover.

10. The heat exchanger according to claim 9, wherein the housing cover and the jacket portion are separate parts joined together by means of mechanical retaining means.

11. The heat exchanger as set forth in claim 9, wherein at least one of the exchanger tube and the housing cover are made from a corrosion and heat resistant material.

12. A method for assembling a heat exchanger for an exhaust gas system of a motor vehicle comprising the steps of:
providing a housing having at least one feed-through point formed therein;
providing an exhaust gas carrying exchanger tube having a first end and a second end;
inserting the exchanger tube in the feed-through point of the housing, the first end and the second end of the exchanger tube located outside the housing;
forming a mechanical support structure on an outer surface of the exchanger tube, the mechanical support structure located within the housing;
forming a mechanical retaining structure on an outer surface of the exchanger tube, the mechanical retaining structure located outside the housing; and
forming a substantially fluid tight seal between the housing and the outer surface of the exchanger tube.

13. The method according to claim 12, wherein the step of forming the mechanical support structure includes expanding a diameter of the exchanger tube.

14. The method according to claim 12, wherein the step of forming the mechanical retaining structure includes expanding a diameter of the exchanger tube.

15. The method according to claim 12, wherein the step of forming the substantially fluid tight seal includes at least one of a soldering, a welding, a crimping, and an adhesive bonding.

16. The method according to claim 15, including the step of coating at least a portion of the exchanger tube with a solder.

17. The method according to claim 15, including the step of coating at least a portion of one of an inner and an outer surface of the housing.

18. A tool for expanding a diameter of a tube comprising:
a mandrel adapted to be received in an end of the tube including at least one section formed from a flexible material; and
an actuator adapted to cause a length of the mandrel to be reduced upon an actuation thereof, wherein the flexible material yields outwardly when the mandrel is at a reduced length causing the flexible material to contact an inner surface of the tube and expand the diameter of the tube.

19. The tool according to claim 18, including two sections of the flexible material to form a pair of spaced apart portions in the tube having an expanded diameter.

20. The tool according to claim 18, wherein the flexible material is rubber.
